(19) United States
(12) Patent Application Publication
(10) Pub. No.: US 2023/0177727 A1
(43) Pub. Date: Jun. 8, 2023

(54) THERMAL RATING ESTIMATION APPARATUS, THERMAL RATING ESTIMATION METHOD, AND PROGRAM

(71) Applicant: NIPPON TELEGRAPH AND TELEPHONE CORPORATION, Tokyo (JP)

(72) Inventors: Hsin-Ni HO, Tokyo (JP); Hiroki TERASHIMA, Tokyo (JP); Shinya NISHIDA, Tokyo (JP)

(73) Assignee: NIPPON TELEGRAPH AND TELEPHONE CORPORATION, Tokyo (JP)

(21) Appl. No.: 17/921,949

(22) PCT Filed: Apr. 30, 2020
(86) PCT No.: PCT/JP2020/018240

§ 371 Date: Oct. 27, 2022

(51) Int. Cl. G06T 7/90

(52) U.S. Cl. CPC G06T 7/90; G06T 2207/10024; G06T 2207/30161; G06T 2207/30124; G06T 2207/30136; G06T 2207/30132; G06T 2207/20084; G06T 2207/20081

(57) ABSTRACT

An evaluation value of a sense of temperature that is closer to human perception is estimated. An image feature amount extraction unit (11) extracts an image feature amount from an input image. A temperature sense estimation unit (12) estimates a temperature sense score from the image feature amount with use of a temperature sense estimation model in which a correlation between the image feature amount and the temperature sense score has been learned in advance. The temperature sense score may be weighted with use of a material weight previously set with respect to the material information corresponding to the input image. As the image feature amount, representative values of coordinates a*, b* in a Lab three-dimensional space or a color histogram in which the Lab three-dimensional space is divided into the predetermined number may be used.

### TECHNICAL FIELD

The present invention relates to a technology of estimating a sense of temperature felt by a human from an image.

### BACKGROUND ART

As conventional art of estimating a sense of temperature felt by a human from an image, Non-Patent Literature 1 has been known. In Non-Patent Literature 1, an evaluation value of a sense of temperature is obtained by converting color information of an image using a predetermined function. In Non-Patent Literature 1, a subject experiment is performed by using a prepared color pattern image, and from the result, a correlation between the color of an image and a sense of temperature felt by a human is expressed.

### CITATION LIST

### Non-Patent Literature

Non-Patent Literature 1: Kawamoto, N. and T. Soen, “Objective evaluation of color design. II,” Color Research & Application, vol. 18(4), pp. 260-266, 1993.

### SUMMARY OF THE INVENTION

### Technical Problem

However, Non-Patent Literature 1 lacks robustness because the number of samples of images used for the experiment is as small as 30 pieces. Further, since artificial color pattern images are used, it is not usable for estimation of a sense of temperature felt by a human with respect to the color under the actual environment.

In view of the technical problem as described above, an object of the present invention is to provide a technology that enables estimation of an evaluation value of a sense of temperature that is closer to human perception.

### Means for Solving the Problem

In order to solve the aforementioned problem, a temperature sense estimation device, according to one aspect of the present invention, includes an image feature amount extraction unit that extracts an image feature amount from an input image, and a temperature sense estimation unit that estimates a temperature sense score from the image feature amount with use of a temperature sense estimation model in which a correlation between the image feature amount and the temperature sense score has been learned in advance.

### Effects of the Invention

According to the present invention, it is possible to estimate an evaluation value of a sense of temperature closer to human perception.

### BRIEF DESCRIPTION OF DRAWINGS

FIG. 1 is a diagram for explaining an experiment result serving as a background of the invention.

FIG. 2 is a diagram illustrating an exemplary functional configuration of a temperature sense estimation device of a first embodiment.

FIG. 3 is a diagram illustrating an exemplary procedure of a temperature sense estimation method of the first embodiment.

FIG. 4 is a diagram illustrating an exemplary functional configuration of a temperature sense estimation device of a third embodiment.

FIG. 5 is a diagram illustrating an exemplary procedure of a temperature sense estimation method of the third embodiment.

FIG. 6 is a diagram illustrating an exemplary functional configuration of a temperature sense estimation device of Modification 1.

FIG. 7 is a diagram illustrating an exemplary procedure of a temperature sense estimation method of Modification 1.

FIG. 8 is a diagram illustrating an exemplary functional configuration of a computer.

### DESCRIPTION OF EMBODIMENTS

Hereinafter, embodiments of the present invention will be described in detail. Note that in the drawings, components having the same function are denoted by the same reference numeral, and overlapping description is omitted.

[Experiment Result]

First, an experiment result serving as a background of the present invention will be described.

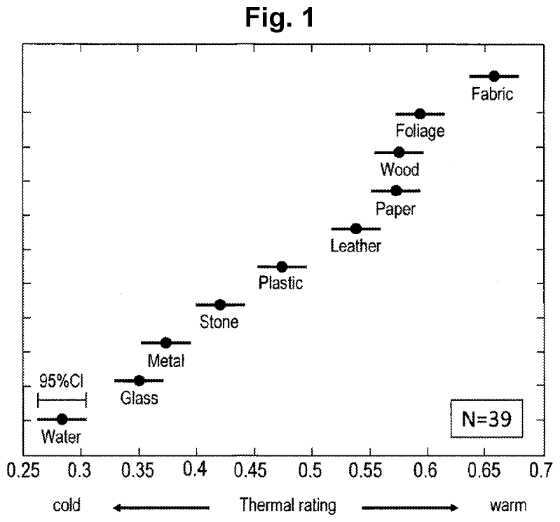

With use of 1934 pieces of texture images belonging to any of prepared ten material categories (water, glass, metal, stone, plastic, leather, paper, wood, plant (foliage), and fabric), data of a sense of temperature with respect to each image felt by thirty nine subjects was put into scores (hereinafter referred to as “temperature sense scores”) ranging from cold (0.0) to warm (1.0). FIG. 1 shows distribution of temperature sense scores given by the subjects with respect to the images of the respective material categories. The horizontal axis shows the temperature sense score (thermal rating), in which a smaller value represents a colder sense and a larger value represents a warmer sense. It is found that distribution of temperature sense scores is clearly divided among the material categories.

In this experiment, among the feature amounts extracted from respective images, a combination that estimates a temperature sense score with high accuracy was learned by the lasso (Reference Document 1). As a result, a strong correlation was found between estimation values and temperature sense scores. On the basis of this experiment result, the present invention extracts a predetermined feature amount from an input image, and puts it into a model obtained through learning, to thereby estimate a temperature sense score.

[Reference Document 1] Tibshirani, R., “Regression shrinkage and selection via the lasso,” Journal of the Royal Statistical Society: Series B (Methodological), vol. 58(1), pp. 267-288, 1996.

### First Embodiment

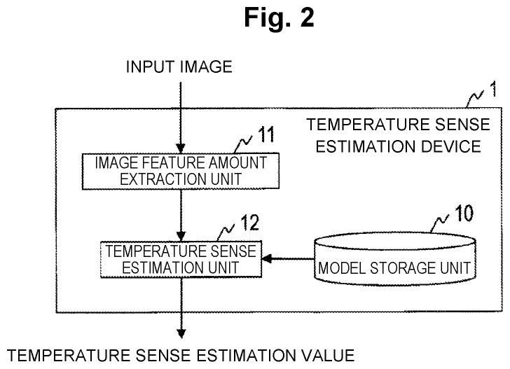

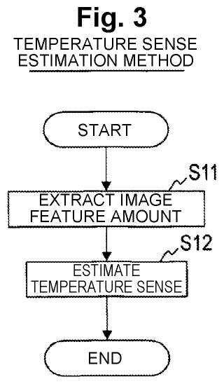

A first embodiment of the present invention is a temperature sense estimation device and a method thereof that use an image that is an object of temperature sense estimation as an input and output an estimation value of the temperature sense of the image. As illustrated in FIG. 2, a temperature sense estimation device 1 of the first embodiment includes, for example, a model storage unit 10, an image feature amount extraction unit 11, and a temperature sense estimation unit 12. A temperature sense estimation method of the first embodiment is realized by execution of processes of the respective steps, illustrated as examples in FIG. 3, by the temperature sense estimation device 1.

The temperature sense estimation device 1 is, for example, a special device configured such that a special program is read in a publicly-known or dedicated computer having a central processing unit (CPU), a main storage device (random access memory (RAM)), and the like. The temperature sense estimation device 1 executes respective processes under control of the central processing unit, for example. Data input to the temperature sense estimation device 1 and data obtained in the respective processes are stored in the main storage device for example, and the data stored in the main storage device is read to the central processing unit as required and is used for another process. At least part of each processing unit of the temperature sense estimation device 1 may be configured by hardware such as an integrated circuit. The storage units provided in the temperature sense estimation device 1 may be configured, for example, by a main storage device such as a random access memory (RAM), an auxiliary storage device configured by a hard disk, an optical disk, or a semiconductor memory element such as a flash memory, or middleware such as a relational database or a key-value store.

Referring to FIG. 3, processing procedure of a temperature sense estimation method executed by the temperature sense estimation device 1 of the first embodiment will be described.

In the model storage unit 10, a temperature sense estimation model is stored. The temperature sense estimation model is a learned model obtained through learning of a correlation between an image feature amount and a temperature sense score in advance by machine learning. The temperature sense estimation model receives an image feature amount as an input and outputs an estimation value of a temperature sense score.

The image feature amount is representative values of coordinates a*, b* in a color space called a Lab three-dimensional space, specifically. Representative values are statistical quantity calculated from a plurality of pixels included in one image that is an object of feature amount extraction. It should be noted that they are not representative values (statistical quantity) of each pixel included in a plurality of pieces of images. Representative values are, for example, a mean. Instead of a mean, a standard deviation (SD), a skew, a kurtosis, or the like may be used. The reason for using representative values of coordinates a*, b* is that in the experiment serving as the above-described background, as a result of performing the lasso by also taking a feature amount such as representative values of an L axis direction into consideration in addition to the representative values of coordinates a*, b*, the representative values of the coordinates a*, b* were the values that well estimated the temperature score. While a mean especially has a high estimation property, a sufficient correlation can be obtained by using a standard deviation (SD), a skew, a kurtosis, and the like, instead of a mean. Therefore, a configuration using any of them is also acceptable.

An example of a learned model is a function expressed by a weighted sum as shown below. Note that a_{mean,common} is a mean of coordinates of a* of a plurality of pixels included in an image, and b_{mean,common} is a mean of coordinates of b* of a plurality of pixels included in an image.

Thermal rating=0.00452*a_{mean,common}+0.0041*b_{mean,common}+0.440

The weight values are obtained through learning using the lasso for the extracted image feature amount by using data acquired from the subject in the experiment serving as the above-described background as learning data. However, the weight values are not limited to those described above. Basically, it is sufficient that value corresponding to the weighted sum of the coordinates a*, b* is obtained as a temperature sense score, and it is sufficient that the weights of the coordinates a*, b* are almost the same.

Further, any learned model obtained through learning of the image feature amount and the temperature sense score using another machine learning method such as a neural network may be used, without being limited to the lasso.

At step S11, the image feature amount extraction unit 11 extracts a predetermined image feature amount from an image input to the temperature sense estimation device 1 (hereinafter referred to as an “input image”). The image feature amount to be extracted is the same as that used for the temperature sense estimation model. The image feature amount extraction unit 11 outputs the extracted image feature amount to the temperature sense estimation unit 12.

At step S12, the temperature sense estimation unit 12 inputs the image feature amount of the input image, received from the image feature amount extraction unit 11, into the temperature sense estimation model stored in the model storage unit 10, and obtains a temperature sense score. The temperature sense estimation unit 12 uses the estimation value of the obtained temperature sense score as an output of the temperature sense estimation device 1.

There are two main different points between Non-Patent Literature 1 and the first embodiment. The first point is that while Non-Patent Literature 1 uses a Luv color space, the first embodiment uses a Lab three-dimensional space. A Lab three-dimensional space is more suitable for the purpose of estimating the surface temperature sense. A Luv color space is generally used for addition and mixing of light due to its linear addition characteristics. A Lab three-dimensional space is more linear perceptually than other color spaces. Perceptually linear means that when a change in the color value is the same quantity, an almost the same visual significance change is caused. Therefore, this space is generally used for a surface color. Moreover, since a* channel is green-red, and b* channel is blue-yellow, the Lab three-dimensional space directly corresponds to warm colors/cold colors.

The second point is a difference in parameters used in the models. The model of Non-Patent Literature 1 uses six parameters. Those parameters include an L mean, a U mean, a V mean, and other spatial frequency parameters derived from Fourie transform. The first embodiment only uses important image statistical quantity selected by using the lasso regression.

### Second Embodiment

In the first embodiment, representative values of coordinates a*, b* in the Lab three-dimensional space are used as the image feature amount. In a second embodiment, a Lab three-dimensional space histogram is used as the image feature amount. Hereinafter, the differences from the first embodiment will be mainly described.

The image feature amount extraction unit 11 extracts a predetermined image feature amount from an input image. Specifically, it is assumed that the image feature amount extraction unit 11 expresses an ab space of the Lab three-dimensional space that is a color expression space as a polar coordinates system, and obtains a color histogram of an image as an image feature amount by using, as a bin, each region obtained by equally dividing a radius vector r (ab space) by a logarithm into fifths, equally dividing the angle of deviation θ into eighths, and equally dividing the L axis direction by a logarithm into fifths. In that case, a histogram having 200 pieces of bins is obtained. However, the number of divisions is not limited thereto. This means that it is only necessary to calculate a color histogram obtained by dividing the Lab three-dimensional space into predetermined bins as the image feature amount.

The temperature sense estimation unit 12 is the same as that of the first embodiment except that an input image feature amount is a color histogram. The learned model in this case is one in which a correlation between a color histogram extracted for each image included in the learning data and a temperature sense score is learned using a machine learning technique such as a neural network. A learned model in the case of being learned by the lasso is expressed as a weighted sum as described below for example.

Thermal rating=−0.025*r₁_L₂+−0.02*r₁_L₃+0.01*r₃_θ₂_L₃+ . . .

Here, rᵢ_θⱼ_Lₖ(i=1, . . . , 5, j=1, . . . , 8, k=1, . . . , 5) is a feature amount of the color histogram, and rᵢ_θⱼ_Lₖ corresponds to the number of pixels included in the bin of (rₗ, θⱼ, Lₖ) where each section obtained by equally dividing the radius vector r by a logarithm into fifths is r₁, . . . , r₅, each section obtained by equally dividing the angle of deviation θ into eighths is θ₁, . . . , θ₈, and each section obtained by equally dividing the L coordinate by a logarithm into fifths is L₁, . . . , L₅. Further, rᵢ_Lₖ=Σⱼ₌₁⁸rᵢ_θⱼ_Lₖ is also established.

### Third Embodiment

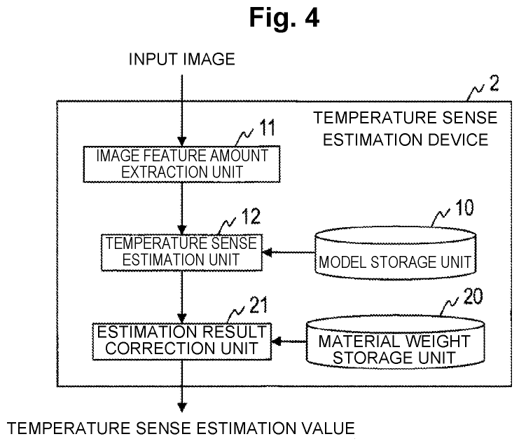

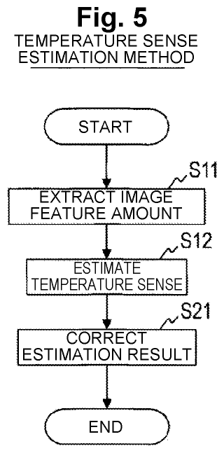

In a third embodiment, in consideration of the material of an object (temperature sense estimation object) included in an image, the temperature sense score estimated in the first embodiment and the second embodiment is corrected. As illustrated in FIG. 4, a temperature sense estimation device 2 of the third embodiment includes, for example, a material weight storage unit 20 and an estimation result correction unit 21, in addition to the model storage unit 10, the image feature amount extraction unit 11, and the temperature sense estimation unit 12. A temperature sense estimation method of the third embodiment is realized by execution of processes of the respective steps, illustrated as examples in FIG. 5, by the temperature sense estimation device 2.

Referring to FIG. 5, processing procedure of a temperature sense estimation method executed by the temperature sense estimation device 2 of the third embodiment will be described by focusing on the differences from the first embodiment.

The material weight storage unit 20 stores therein a material weight for each material category in association with each other. The material weight is calculated in advance by using a feature amount extracted from a material image belonging to its material category. Here, a material weight value is assumed to be a fixed value calculated from the feature amount for each material category. For example, an average value of the feature amounts calculated for each material category is used. Table 1 shows exemplary material weights stored in the material weight storage unit 20. Values of the material weights are not limited thereto, and may vary slightly. However, it is desirable that the magnitude relationship among the material categories is such that the relationship shown in Table 1 is maintained.

TABLE 1

| | |
|---|---|
| Material ID | Material Weight |

| | | |
|---|---|---|
| 1 | (Fabric) | 0.65 |
| 2 | (Foliage) | 0.6 |
| 3 | (Wood) | 0.58 |
| 4 | (Paper) | 0.57 |
| 5 | (Leather) | 0.54 |
| 6 | (Plastic) | 0.47 |
| 7 | (Stone) | 0.43 |
| 8 | (Metal) | 0.37 |
| 9 | (Glass) | 0.35 |
| 10 | (Water) | 0.28 |

The temperature sense estimation model stored in the model storage unit 10 of the third embodiment is assumed to be obtained through learning of a correlation between an image feature amount and a corrected temperature sense score in advance by machine learning. A corrected temperature sense score is a score in which a material weight value (for example, an average value of feature amounts calculated for each material category) is subtracted from a temperature sense score. For example, in the case of an image of fabric whose temperature sense score is 0.90, the corrected temperature sense score is 0.90−0.65=0.25.

At step S21, the estimation result correction unit 21 acquires the material weight corresponding to the input image from the material weight storage unit 20, and with use of it, corrects the temperature sense score estimated by the temperature sense estimation unit 12. Specifically, a value obtained by adding the material weight to the temperature sense score estimated by the temperature sense estimation unit 12 is output as a corrected temperature sense score.

The estimation result correction unit 21 acquires the material weight as described below. In the case where information of the material category of the image is given in advance together with the input image, the material weight storage unit 20 may be searched for a corresponding material weight with use of the information. Alternatively, material information corresponding to the input image may be input by an external input (manually, for example). Besides, it is also possible to have a configuration of allowing a classifier that classifies an image into a material category to learn by means of a support vector machine (SVM), clustering, or the like in advance, and with use of the classification result (material category) estimated by inputting an input image into the learned classifier, acquiring the corresponding material weight from the material weight storage unit 20.

Note that when the corresponding material category is not stored in the material weight storage unit 20, a correction process by the estimation result correction unit 21 will not be performed. Alternatively, a correction process may be performed with a material weight being zero.

<Modification 1>

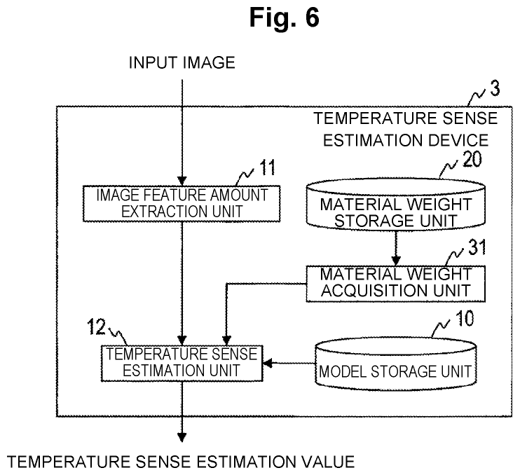

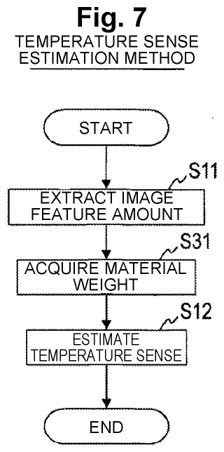

The third embodiment is configured such that a temperature sense score estimated by the temperature sense estimation unit 12 is corrected afterward. In Modification 1, it is configured such that the temperature sense estimation unit 12 calculates a temperature sense score while considering the material weight as well. As illustrated in FIG. 6, a temperature sense estimation device 3 of Modification 1 includes, for example, a material weight acquisition unit 31, in addition to the model storage unit 10, the image feature amount extraction unit 11, the temperature sense estimation unit 12, and the material weight storage unit 20. A temperature sense estimation method of Modification 1 is realized by execution of processes of the respective steps, illustrated as examples in FIG. 7, by the temperature sense estimation device 3.

Referring to FIG. 7, processing procedure of a temperature sense estimation method executed by the temperature sense estimation device 3 of Modification 1 will be described by focusing on the differences from the third embodiment.

The material weight storage unit 20 of Modification 1 stores therein a material weight calculated by machine learning in advance for each material category in association with each other. A material weight is learned as described below. Learning data as shown in the background experiment (a learning data set in which images and temperature sense scores are associated with each other) is prepared. Then, an image feature amount is extracted from an image. At the time of learning by the lasso, in addition to the image feature amount, learning is made with addition of a feature amount “one” corresponding to the material. Note that the value of the material feature amount “one” is assumed to be a constant (1). At the time of learning, learning is performed with expansion of each feature amount using Frustratingly Easy Domain Adaptation (Reference Document 2). Thereby, the material feature amount is developed to a feature amount of each material category such as oneₛₜₒₙₑ, one_{water}, . . . . By performing learning by the lasso with use of the feature amount developed in this manner, it is possible to allow learning of the weight of the feature amount corresponding to each material category. Such a weight may be used as a material weight. For example, when the material is “stone”, the weight value of the material feature amount oneₛₜₒₙₑ can be used as a material weight Cₛₜₒₙₑ.

[Reference Document 2] Daume′ III, H., “Frustratingly Easy Domain Adaptation,” Proceedings of the 45th Annual Meeting of the Association of Computational Linguistics, pp. 256-263, June 2007.

At step S31, the material weight acquisition unit 31 acquires a material weight corresponding to the input image. A method of acquiring the material weight is the same as that performed by the estimation result correction unit 21 of the third embodiment.

The temperature sense estimation unit 12 of Modification 1 obtains a temperature sense score from the image feature amount calculated by the image feature amount extraction unit 11 on the basis of a preset correlation between the image feature amount as well as the material weight and the temperature sense score, and outputs it. Specifically, an estimation value of a temperature sense score is obtained by inputting the image feature amount extracted from the input image into the learned temperature sense estimation model obtained through learning of the correlation between the image feature amount as well as the material weight and the temperature sense score in advance by machine learning, and output. For example, in the case of using the lasso, a temperature sense score is estimated from the weighted sum of the image feature amount and the material weight as provided below. Note that C_{category} represents a material weight.

Thermal rating=0.00458*a_{mean,common}+0.00403*b_{mean,common}+0.433+C_{category}

<Modification 2>

According to the background experiment, it has been found that the feature amount of the L* coordinate system of the Lab space feature amount has a high estimation property in the case where the material is metal, while not having large contribution to other materials. On the basis of such findings, Modification 1 may be configured such that only when the material is metal, the image feature amount extraction unit 11 further calculates also a representative value of the feature amount of the L* coordinate system, and the temperature sense estimation unit 12 calculates a temperature sense score while also taking into account the feature amount of the L* coordinate system. In that case, a temperature sense score is calculated by also using the correlation with the feature amount of the L* coordinate system.

[Exemplary Application]

According to the present invention, since it is possible to quantify the sense of temperature felt by a human with respect to an object, an impression of the temperature sense felt by a human can be easily grasped intuitively. For example, in designs and coordinates of products such as interiors of shops, buildings, and the like, furniture, home appliances, clothes, and fashion, an impression of the temperature sense given by a color arrangement to a human can be quantified. Therefore, by adjusting the color arrangement and repeating a process of estimating the temperature sense score in response to a request for warmer feeling or the like, color arrangement design can be performed easily. Alternatively, even in the case of desiring warm feeling with respect to a metal product that is the same as the feeling with respect to fabric, for example, by calculating the temperature sense score by the present invention and changing the color arrangement such that the score becomes closer to the temperature sense score of fabric (for example, 0.63 to 0.68), it is possible to realize color arrangement design that matches the need.

Further, in the present invention, since the temperature sense score of the entire image can be estimated, it is possible to quantify the sense of temperature perceived by a human with respect to a material in which a plurality of colors are mixed rather than a single color and the entire space where a plurality of colors are arranged such as the interior of a room. Thereby, it is possible to intuitively grasp a change in the impression of the sense of temperature as a whole provided by changing a part of the interior or a part of the color arrangement. As a result, it is possible to facilitate creation of a design corresponding to customer needs or succession of a color arrangement sense to another person that is difficult to explain with words, for example.

While embodiments of the present invention have been described above, the specific configuration is not limited to these embodiments. It is needless to say that any appropriate changes in design or the like within a scope not deviating from the spirit of the present invention are included in the present invention. The respective types of processes described in the embodiments may be performed not only in a time-series manner according to the order described but may be performed in parallel or individually according to the processing capacity of the device that performs the processes or as required.

[Program, Recording Medium]

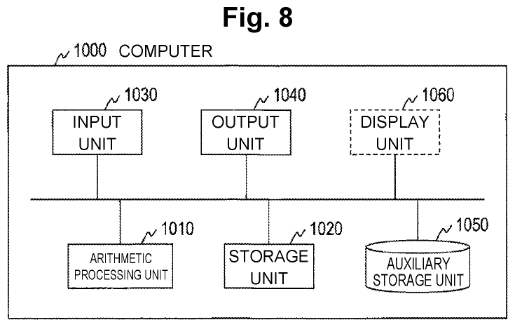

In the case of implementing the respective types of processing functions in the respective devices described in the embodiments by a computer, the processing contents of the functions that should be held by the respective devices are described by a program. Then, when a storage unit 1020 of the computer illustrated in FIG. 8 is allowed to read the program, and an arithmetic processing unit 1010, an input unit 1030, an output unit 1040, and the like are allowed to operate, the processing functions of the respective types in the respective devices are implemented on the computer.

The program describing the processing contents can be recorded on a computer-readable recording medium. A computer-readable recording medium is, for example, a non-transitory recording medium such as a magnetic recording device or an optical disk.

Moreover, distribution of the program is performed by, for example, selling, assigning, lending, or the like a portable recording medium such as a DVD or a CD-ROM on which the program is recorded. Furthermore, it is acceptable to have a configuration in which the program may be distributed by being stored in a storage device of a server computer and being transferred from the server computer to another computer over a network.

A computer that executes such a program, first, temporarily stores the program recorded on a portable recording medium or the program transferred from the server computer, in an auxiliary recording unit 1050 that is a non-transitory storage device of its own, for example. Then, at the time of executing a process, the computer reads the program stored in the auxiliary recording unit 1050 that is a non-transitory storage device of its own into the storage unit 1020 that is a transitory storage device, and executes the process according to the read program. Further, as another execution mode of the program, the computer may read the program directly from a portable recording medium and execute the process according to the program, or each time the program is transferred to the computer from the server computer, the computer may sequentially execute the process according to the received program. Furthermore, it is also possible to have a configuration of executing the process described above by a service in which transfer of the program to the computer from the server computer is not performed and a processing function is implemented only by the execution instruction thereof and acquisition of the result, that is, a so-called application service provider (ASP) type service. Note that the program of the present mode includes information to be provided for processing by an electronic computing machine and is equivalent to the program (data that is not a direct command to the computer but has a property of defining processing by the computer, or the like).

Further, while it is described that the present device is configured by execution of a predetermined program on a computer in this mode, at least part of the processing content may be implemented by hardware.

1. A temperature sense estimation device comprising a processor configured to execute a method comprising:
extracting an image feature amount from an input image; and
estimating a temperature sense score from the image feature amount with use of a temperature sense estimation model in which a correlation between the image feature amount and the temperature sense score has been learned in advance.

2. The temperature sense estimation device according to claim 1, the processor further configured to execute a method comprising:
generating a combined weight value based on the temperature sense score and a predetermined material weight value associated with material information corresponding to the input image.

3. The temperature sense estimation device according to claim 1, wherein
the image feature amount includes representative values of coordinates a*, b* in a Lab three-dimensional space.

4. The temperature sense estimation device according to claim 1, wherein
the image feature amount includes a color histogram in which a Lab three-dimensional space is divided into a predetermined number.

5. A computer implemented method for estimating a temperature sense, the method comprising:
extracting an image feature amount from an input image; and
estimating a temperature sense score from the image feature amount with use of a temperature sense estimation model in which a correlation between the image feature amount and the temperature sense score has been learned in advance.

6. A computer-readable non-transitory recording medium storing computer-executable program instructions that when executed by a processor cause a computer system to execute a method comprising:
extracting an image feature amount from an input image; and
estimating a temperature sense score from the image feature amount with use of a temperature sense estimation model in which a correlation between the image feature amount and the temperature sense score has been learned in advance.

7. The temperature sense estimation device according to claim 1, wherein the temperature sense estimation model estimates the temperature sense score based on the image feature amount as input, and wherein the temperature sense estimation model includes a weighted sum comprising a mean of coordinates of a plurality of pixels in an image and another mean of coordinates of another plurality of pixels in the image.

8. The temperature sense estimation device according to claim 1, wherein the temperature sense estimation model includes a machine learning model based on a neural network, and wherein the neural network is learnt based on a sample image feature value and the temperature sense score as training data.

9. The temperature sense estimation device according to claim 1, wherein the temperature sense estimation model includes parameters with values according to a lasso regression.

10. The temperature sense estimation device according to claim 2, wherein the material information based on a material category, wherein the material category includes fabric, wood, paper, and leather, and wherein the predetermined material weight value represents a degree of correcting the temperature sense score according to a material of an object in the input image.

11. The temperature sense estimation device according to claim 2, wherein
the image feature amount includes representative values of coordinates a*, b* in a Lab three-dimensional space.

12. The temperature sense estimation device according to claim 2, wherein
the image feature amount includes a color histogram in which a Lab three-dimensional space is divided into a predetermined number.

13. The computer implemented method according to claim 5, further comprising:
generating a combined weight value based on the temperature sense score and a predetermined material weight value associated with material information corresponding to the input image.

14. The computer implemented method according to claim 5, wherein
the image feature amount includes representative values of coordinates a*, b* in a Lab three-dimensional space.

15. The computer implemented method according to claim 5, wherein
the image feature amount includes a color histogram in which a Lab three-dimensional space is divided into a predetermined number.

16. The computer implemented method according to claim 5, wherein the temperature sense estimation model estimates the temperature sense score based on the image feature amount as input, and wherein the temperature sense estimation model includes a weighted sum comprising a mean of coordinates of a plurality of pixels in an image and another mean of coordinates of another plurality of pixels in the image.

17. The computer implemented method according to claim 5, wherein the temperature sense estimation model includes a machine learning model based on a neural network, and wherein the neural network is learnt based on a sample image feature value and the temperature sense score as training data.

18. The computer implemented method according to claim 13, wherein the material information based on a material category, wherein the material category includes fabric, wood, paper, and leather, and wherein the predetermined material weight value represents a degree of correcting the temperature sense score according to a material of an object in the input image.

19. The computer-readable non-transitory recording medium according to claim 6, the computer-executable program instructions when executed further causing the computer system to execute a method comprising:
generating a combined weight value based on the temperature sense score and a predetermined material weight value associated with material information corresponding to the input image.

20. The computer-readable non-transitory recording medium according to claim 6, wherein the temperature sense estimation model includes a machine learning model based on a neural network, and wherein the neural network is learnt based on a sample image feature value and the temperature sense score as training data.
